(19) United States
(12) Patent Application Publication
(10) Pub. No.: US 2025/0161876 A1
(43) Pub. Date: May 22, 2025

(54) SYSTEMS AND METHODS FOR PERFORMING DIRECT AIR CAPTURE WITH THE ASSISTANCE OF A RECIRCULATING BUFFER FLUID FOR GENERATION OF A PARTIALLY ENRICHED STREAM OF CARBON DIOXIDE FROM CHEMICAL MEDIA

(71) Applicant: Clairity Technology Inc., Culver City, CA (US)

(72) Inventors: Glen MEYEROWITZ, Pacific Palisades, CA (US); Kersh THEVASUNDARAM, Culver City, CA (US)

(21) Appl. No.: 19/035,224

(22) Filed: Jan. 23, 2025

Related U.S. Application Data
(63) Continuation of application No. PCT/US2023/071117, filed on Jul. 27, 2023.
(60) Provisional application No. 63/369,658, filed on Jul. 27, 2022.
(60) Provisional application No. 63/413,902, filed on Oct. 6, 2022.

(51) Int. Cl. B01D 53/62; B01D 53/82; B01D 53/96; C01B 32/50; F17C 11/00

(52) U.S. Cl. CPC B01D 53/62; B01D 53/82; B01D 53/96; C01B 32/50; F17C 11/00; B01D 2251/606; B01D 2257/504; B01D 2258/06; B01D 2259/4009; F17C 2221/013; F17C 2223/0115

(57) ABSTRACT

Embodiments described herein relate to DAC of CO₂ and the associated adsorption, desorption, or regeneration, and storage of the CO₂. In some embodiments, a system can include a contactor including a chemical medium including the adsorption medium, the adsorption medium configured to adsorb CO₂ from ambient air; a circulator configured to circulate a buffer fluid to desorb CO₂ from the adsorption medium to produce dilute CO₂; and a storage volume configured to store the dilute CO₂. In some embodiments, the dilute CO₂ can have a concentration between about 0.5% and about 60% by volume. In some embodiments, the dilute CO₂ can be stored in the storage volume in the form of liquid CO₂, gaseous CO₂, supercritical CO₂ and/or CO₂ dissolved in water. In some embodiments, the contactor can include a porous honeycomb monolith contactor, the porous honeycomb monolith contactor having chemical media including the adsorption medium impregnated therein or coated thereon. In some embodiments, the chemical media can include an amine, a carbonate, and/or an alkaline solvent.

### CROSS-REFERENCE TO RELATED APPLICATIONS

This application claims priority to and the benefit of U.S. Provisional Patent Application No. 63/369,658 entitled, “Method for Performing Direct Air Capture in Multiple Steps Utilizing Recirculating Buffer Fluid for Desorption of Carbon Dioxide from a Chemical Media,” filed Jul. 27, 2022; and U.S. Provisional Patent Application No. 63/413,902 entitled, “Systems and Methods for Performing Direct Air Capture Via Recirculating Buffer Fluid for Desorption of Carbon Dioxide from Chemical Media,” filed Oct. 6, 2022; the disclosure of each of which is incorporated herein by reference in their entirety.

### TECHNICAL FIELD

Embodiments described herein relate to direct air capture (DAC) of carbon dioxide (CO₂) and storage of the capture medium.

Background

The monthly mean CO₂ concentration measured at the Mauna Loa Observatory, Hawaii in March 2022 was 418.81 ppm. This value is up nearly 50% from pre-industrial levels and over 32% since measurements were started at Mauna Loa in 1958. Carbon dioxide removal (CDR) is a family of solutions, both natural and technology-based, which remove CO₂ from the atmosphere. As stated by the United States Department of Energy, “CDR encompasses a wide array of approaches, including DAC coupled to durable storage, soil carbon sequestration, biomass carbon removal and storage, enhanced mineralization, ocean-based CDR, and afforestation/reforestation. CDR does not refer to point source carbon capture for the fossil fuel or industrial sector. Paired with simultaneous deployment of mitigation measures and other carbon management practices, CDR is a tool to address emissions from the hardest to decarbonize sectors—like agriculture and transportation—and to eventually remove legacy CO₂ emissions from the atmosphere.”

While there is a wide array of approaches to CDR, no current technologies exist which can economically and cost effectively remove CO₂ from the atmosphere. Scientists and economists estimate that it will be necessary for this technology to remove CO₂ at a cost below 100 USD per metric ton of CO₂ (tCO₂). If this price point can be achieved, it may be viable to scale this technology and mitigate the most dramatic impacts of climate change. Reliance on overly complex system hardware and architecture prevent current solutions from achieving the target goal, as both the capital expenditure (capex) and operational expenditures (opex) are too large. Thus, there is a need in the art for a novel method of performing direct air capture that allows for increased efficiency and reduced capital and operational expenditures.

### SUMMARY

Embodiments described herein relate to DAC of CO₂ and the associated desorption and storage of the CO₂. In some embodiments, a system can include a contactor including an adsorption medium, the adsorption medium configured to adsorb CO₂ from ambient air, a circulator configured to circulate a buffer fluid to desorb CO₂ from the adsorption medium to produce dilute CO₂, and a storage volume configured to store the dilute CO₂. In some embodiments, the dilute CO₂ can have a concentration between about 0.5% and about 60% by volume. In some embodiments, the dilute CO₂ can be stored in the storage volume in the form of gaseous CO₂, liquid CO₂, supercritical CO₂ and/or CO₂ dissolved in water. In some embodiments, the contactor can include a porous honeycomb monolith contactor, the porous honeycomb monolith contactor having chemical media including the adsorption medium impregnated therein or coated thereon. In some embodiments, the chemical media can include an amine, a carbonate, and/or an alkaline solvent.

In some embodiments, a method can include contacting ambient air with a chemical media to adsorb CO₂ from the ambient air, desorbing at least a portion of the CO₂ from the chemical media to form a dilute CO₂ stream, the dilute stream of CO₂ having a CO₂ concentration between about 10% and about 30% by volume, and storing the dilute CO₂ stream in a storage volume. In some embodiments, the chemical media can include a solid and/or a liquid. In some embodiments, the chemical media can include an amine, a carbonate, and/or an alkaline solvent.

### BRIEF DESCRIPTION OF THE DRAWINGS

FIG. 1 is a block diagram of a system for capturing CO₂ from ambient air, according to an embodiment.

FIG. 2 is a flow diagram of a method for capturing CO₂ from ambient air, according to an embodiment.

FIG. 3 is an illustration of a set of fans for delivering ambient air to a contactor, according to an embodiment.

FIG. 4 is an illustration of a contactor and associated equipment during a desorption phase, according to an embodiment.

### DETAILED DESCRIPTION

DAC is a process of capturing CO₂ from ambient air to create a more concentrated fluid. For instance, ambient air typically has a concentration of CO₂ of approximately 0.04% by volume. Often, the output of a DAC process can be a more concentrated stream of between about 10 and about 20%, or as high as 98%, or higher. As long as the output fluid stream is more concentrated than the input ambient air stream, this can be considered direct air capture.

The process for DAC occurs when air makes contact with a chemical media, the chemical media either in a liquid, solid, or hybrid form. The chemical media may include a sorbent or solvent which causes a reaction with the CO₂ in the air, whereby the CO₂ may chemically or physically bond to the chemical media. It can be desirable to have a large contact surface area to perform DAC to allow for the most transfer to occur between the chemical media and the air for capture of CO₂. Once the CO₂ has been captured by the chemical media, the CO₂ can be released in a controlled way. The controlled release of CO₂ can aid in controlling the CO₂ concentration in a chamber where the CO₂ is released. Controlled release of CO₂ can allow a higher purity, more concentrated stream of CO₂ to be generated as an output of the DAC process. Often, energy can be input into the process at this phase in order to release the CO₂. The energy can be input by raising the temperature, performing pressure swings, humidity swings, applying voltage/current, and/or other methods depending on the chemical media. This input of energy can break the chemical or physical bonds and release the CO₂ into the chamber where the reactor exists.

Embodiments described herein relate to systems and methods for performing DAC, including technology for both controlled capture and release of CO₂. In some embodiments, the methods for performing DAC may be more economical and cost effective compared with existing technologies, thus resulting in improvements in scaling. Embodiments described herein are agnostic to the form of the chemical media and may be practiced with either solid, liquid, or hybrid chemical media.

In the adsorption phase, ambient air is moved in large volume over a contactor. In some embodiments, the contactor can include a honeycomb monolith. The honeycomb monolith can increase the surface area per unit volume of the contactor more than non-honeycomb geometries. In some embodiments, the honeycomb monolith may be coated or impregnated with a solid sorbent in order to provide the chemical media with increased surface area to perform mass transfer with the ambient air. The use of a honeycomb monolith also provides a decreased pressure drop per unit volume compared with other types of reactor bed designs. In some embodiments, the design of the reactor bed may be a different geometry than a honeycomb monolith.

The adsorption phase occurs for a given duration. In some embodiments, the duration of the adsorption phase may be based on time or a different trigger, such as measuring the concentration of CO₂ in the exhaust gas that leaves the reactor. Initially, the concentration of CO₂ in the exhaust gas is low as the reactor is performing with high efficiency as the chemical media is adsorbing as much CO₂ from the ambient air as it can. As the cycle continues, the chemical media will become increasingly saturated with CO₂ and the resulting exhaust gas from the reactor will have increasing concentrations of CO₂. In some embodiments, the system may operate based on an algorithm to minimize the total system energy based on the inlet and exhaust concentration of CO₂ to the reactor.

In the regeneration phase, the CO₂ that has been previously adsorbed from the chemical media is released. The specific process for regeneration may vary depending on the chemical media. In some embodiments, the regeneration can be via thermal desorption, vacuum or pressure swing regeneration, humidity/temperature swing desorption, or any other methods of regenerating CO₂ from the chemical media or combinations thereof. Regeneration can occur inside of a reactor. In some embodiments, the reactor vessel can be closed to minimize the exchange of fluid within the reactor with ambient air that is located outside of the reactor. In some embodiments, the reactor may be a sealed pressure vessel that is leak tight to some target volume of fluid. For example, the reactor may be sealed such that less than about 10 ml of fluid can be exchanged between the inside and outside of the reactor vessel at a differential pressure of greater than about 10 mbar. In some embodiments, the reactor may not be a sealed pressure vessel, such that any significant differential pressure between the inside and outside of the reactor would cause an exchange of fluid in the direction of the pressure differential.

During regeneration, the reactor may include a buffer fluid which can be recirculated within the reactor volume. In some embodiments, the buffer fluid can be air, carbon dioxide, steam (water vapor at elevated temperature or pressure, depending on the phase diagram state point), or any other suitable fluid or combinations thereof. As regeneration occurs, an increasing mass of CO₂ gas will be desorbed from the chemical media. This CO₂ gas will mix and distribute evenly within the buffer fluid and may increase the partial pressure of CO₂ in the buffer fluid as it does so. By measuring the partial pressure of CO₂ gas in the buffer fluid, it is possible to determine the amount of CO₂ that has been regenerated and the efficiency of regeneration. The buffer fluid may also serve as a method of transferring energy required for regeneration to the chemical media. This may be done by increasing the humidity or partial pressure of water vapor in the buffer fluid, increasing the temperature of the buffer fluid, and/or by changing other physical or chemical parameters of the buffer fluid in order to achieve desired regeneration parameters suited to the specific chemical media. In some embodiments, the regeneration parameters may be unique to each chemical media.

In some embodiments, the reactor vessel may include an additional volume which can be used to aid in storing the CO₂ which is regenerated to prevent the pressure within the reactor from increasing, thus avoiding an increased differential pressure between the inside of the reactor vessel and the ambient air outside of the reactor. For instance, there may be a gas bag included within the reactor system that can expand or contract as CO₂ is regenerated into the reactor system. During regeneration, the net volume of the reactor would therefore increase as the pressure within the system remains relatively constant due to the inclusion of the gas bag. Thus, it may be necessary to sense and monitor the volume of the reactor vessel and gas bag to quantify the amount of CO₂ which has been regenerated during this phase. There are multiple possible implementations of the additional volume to the reactor which can be used to prevent pressure increase during desorption. In some embodiments, the additional volume can be provided via a gas bag, a piston system, and/or any other variable volume container.

The implementation of a carbon dioxide removal (CDR) DAC system for removal of CO₂ from the ambient air with the use of a recirculating buffer fluid system allows for the cost-effective capture of CO₂. This system can have reduced capital expense due to the simplified reactor design and the fact that this system does not require a reactor which is necessarily a sealed pressure vessel with low leak rates between the reactor volume and the ambient air at high differential pressures. Additionally, the use of the buffer fluid as a heat and energy transfer media to allow for regeneration to occur will reduce expenses related to operating this system. The output steam from this process may have a variable concentration of CO₂, but the CO₂ concentration is elevated from ambient conditions. This system may be implemented to achieve any target CO₂ purity greater than ambient based on the duration of regeneration and the specific parameters of the reactor design.

Regeneration may occur at a range of pressures in order to enhance regeneration based on the chemical sorbent. In some embodiments, regeneration may occur at ambient pressure. In some embodiments, regeneration may occur at elevated pressure, below ambient pressure, and/or by increasing the pressure of the buffer fluid within the reactor. In some embodiments. regeneration may occur at sub-atmospheric or vacuum pressures by evacuating the reactor vessel prior to starting regeneration. The pressure within the reactor vessel may change during the course of regeneration, based on the optimal conditions for the chemical media. In some embodiments, regeneration can occur in the absence of a vacuum. Regardless of the pressure within the reactor vessel during the regeneration phase, a recirculating buffer gas can be utilized with a differential pressure created by a pump, gas booster, or other modality to allow the buffer fluid to flow within the reactor vessel to collect CO₂ that is being regenerated and transfer energy to the chemical media to aid in regeneration.

The use of a vacuum system can increase the cost and complexity of a DAC system. A vacuum is typically used if a sorbent is not thermally stable in the presence of oxygen or if the impurities within the reactor vessel (i.e., ambient air) would impact the final purity of the CO₂ stream. Vacuums can contribute about 5% of the cost to the total system energy costs but have a much more significant contribution to capital costs. Therefore, operating a DAC system in an environment that is not subject to a vacuum can significantly reduce the costs associated with the system.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of contactors, the set of contactors can be considered as one contactor with multiple portions, or the set of contactors can be considered as multiple, distinct contactors. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

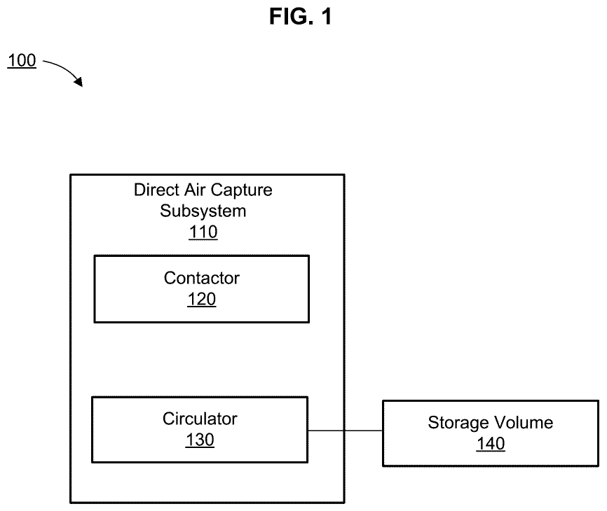

FIG. 1 is a block diagram of a system 100 for capturing CO₂ from ambient air, according to an embodiment. As shown, the system 100 includes a direct air capture subsystem 110 with a contactor 120 and a circulator 130, and a storage volume 140. In use, ambient air contacts the contactor 120 and CO₂ from the ambient air adsorbs to a chemical media in the contactor 120. In some embodiments, ambient air contacts the contactor 120 and the chemical media in the contactor 120 absorbs the CO₂ from the ambient air. The circulator 130 circulates a buffer fluid that desorbs at least a portion of the adsorbed CO₂ from the chemical media and circulates a dilute stream of CO₂, whereby a portion of the dilute stream of CO₂ is captured in a bag and stored, and a portion of the dilute stream of CO₂ is circulated back to the contactor 120.

The contactor 120 includes a chemical media for adsorbing CO₂ from the ambient air. In some embodiments, a fan can facilitate movement of the ambient air to the contactor 120. In some embodiments, the contactor 120 can include a honeycomb monolith. Honeycomb monoliths can be specifically designed to increase surface area per unit volume, more than non-honeycomb geometries. In some embodiments, the contactor 120 can include a carbon extruded monolith impregnated with carbonates to capture CO₂. In some embodiments, the contactor 120 can be impregnated or coated with a solid sorbent. In some embodiments, the solid sorbent can include a chemical media with increased surface area that performs mass transfer with the ambient air. Honeycomb monoliths can also provide a decreased pressure drop per unit volume compared with other reactor bed designs.

The circulator 130 circulates a buffer fluid. The buffer fluid contacts the contactor 120 and desorbs at least a portion of the CO₂ from the contactor 120. In some embodiments, the buffer fluid can include a liquid and the circulator 130 can include a pump. In some embodiments, the buffer fluid can include a gas and the circulator 130 can include a blower.

The storage volume 140 stores CO₂ desorbed from the contactor 120. In some embodiments, the storage volume 140 can include a gas bag. In some embodiments, the storage volume 140 can include a well for geologic injection. In some embodiments, the gas bag can be contained in the same vessel as the contactor 120. The gas bag can store the CO₂ desorbed from the contactor 120 and aid in preventing pressure increase inside the vessel. In some embodiments, the well can be external to the vessel that contains the contactor 120. In some embodiments, the storage volume 140) can include a basalt-rich well. In some embodiments, the storage volume 140 can be located at the same facility as the direct air capture subsystem 110. In some embodiments, the storage volume 140 can be located at a separate facility from the direct air capture subsystem 110, such that the desorbed CO₂ is transported to the storage volume 140.

In some embodiments, the system 100 can include an intermediary storage volume (not shown), where the dilute CO₂ can be stored before being stored in the storage volume 140. In some embodiments, the intermediary storage volume can include a gas bag. In some embodiments, the dilute CO₂ can be stored in the intermediary storage volume for a predetermined duration. In some embodiments, the gas bag can be in-line with the contactor 120 and the circulator 130, such that the CO₂ concentration in the gas bag is the same or substantially similar to the CO₂ concentration in the stream that is recirculated through the contactor 120.

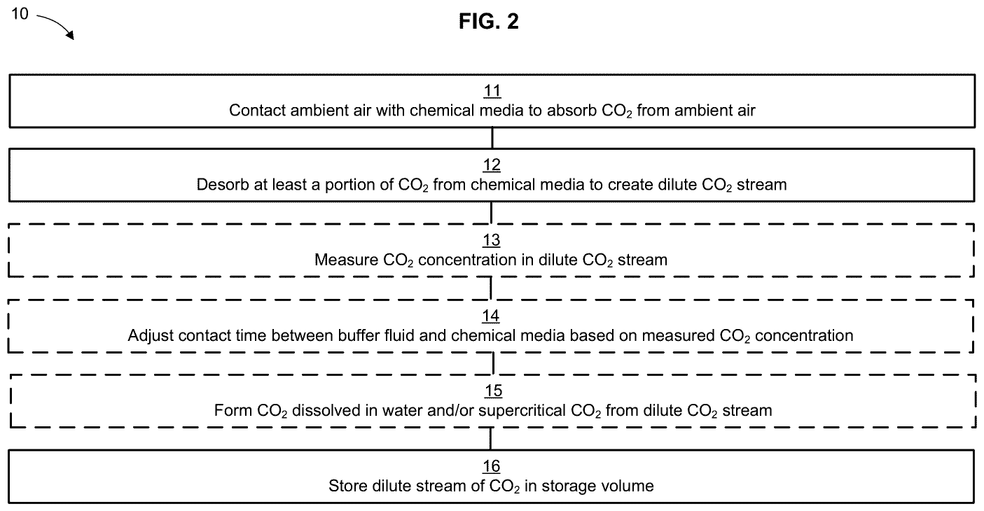

FIG. 2 is a flow diagram of a method 10 for capturing CO₂ from ambient air, according to an embodiment. As shown, the method 10 includes contacting ambient air with a chemical media to adsorb CO₂ from the ambient air at step 11 and desorbing at least a portion of the CO₂ from the chemical media to form a dilute CO₂ stream at step 12. The method 10 optionally includes measuring a CO₂ concentration in the CO₂ stream at step 13; adjusting contact time between the buffer fluid and the chemical media based on the measured CO₂ concentration at step 14; and forming liquid CO₂, gaseous CO₂, aqueous CO₂ and/or supercritical CO₂ from the dilute CO₂ stream at step 15. The method 10 further includes storing the dilute stream of CO₂ in a storage volume at step 16.

Step 11 includes contacting ambient air with the chemical media to adsorb CO₂ from the ambient air. In some embodiments, the chemical media may absorb CO₂ when in contact with ambient air. In some embodiments, step 11 can include blowing the ambient air toward the chemical media via a fan or multiple fans. In some embodiments, the chemical media can include an amine, a carbonate, and/or an alkaline solvent. In some embodiments, the chemical media can be incorporated into a contactor with a honeycomb monolith shape. In some embodiments, the chemical media can include a solid chemical media. In some embodiments, the chemical media can include a liquid chemical media. In some embodiments, the chemical media can include a hybrid solid/liquid media. In some embodiments, the adsorption can be done without employing a vacuum.

In some embodiments, the ambient air can be fed to a vessel containing the chemical media at a rate of at least about 5 (metric) tons/hr, at least about 10 tons/hr, at least about 15 tons/hr, at least about 20 tons/hr, at least about 25 tons/hr, at least about 30 tons/hr, at least about 35 tons/hr, at least about 40) tons/hr, or at least about 45 tons/hr. In some embodiments, the ambient air can be fed to the vessel containing the chemical media at a rate of no more than about 50 tons/hr, no more than about 45 tons/hr, no more than about 40) tons/hr, no more than about 35 tons/hr, no more than about 30) tons/hr, no more than about 25 tons/hr, no more than about 20 tons/hr, no more than about 15 tons/hr, or no more than about 10 tons/hr. Combinations of the above-referenced ambient air feed rates are also possible (e.g., at least about 5 tons/hr and no more than about 50 tons/hr or at least about 15 tons/hr and no more than about 50 tons/hr), inclusive of all values and ranges therebetween. In some embodiments, the ambient air can be fed to a vessel containing the chemical media at a rate of about 5 tons/hr, about 10 tons/hr, about 15 tons/hr, about 20 tons/hr, about 25 tons/hr, about 30 tons/hr, about 35 tons/hr, about 40) tons/hr, about 45 tons/hr, or about 50 tons/hr.

In some embodiments, the chemical media can capture at least about 1 kg/hr, at least about 2 kg/hr, at least about 3 kg/hr, at least about 4 kg/hr, at least about 5 kg/hr, at least about 6 kg/hr, at least about 7 kg/hr, at least about 8 kg/hr, at least about 9 kg/hr, at least about 10) kg/hr, at least about 11 kg/hr, at least about 12 kg/hr, at least about 13 kg/hr, at least about 14 kg/hr, at least about 15 kg/hr, at least about 16 kg/hr, at least about 17 kg/hr, at least about 18 kg/hr, or at least about 19 kg/hr of CO₂. In some embodiments, the chemical media can capture no more than about 20 kg/hr, no more than about 19 kg/hr, no more than about 18 kg/hr, no more than about 17 kg/hr, no more than about 16 kg/hr, no more than about 15 kg/hr, no more than about 14 kg/hr, no more than about 13 kg/hr, no more than about 12 kg/hr, no more than about 11 kg/hr, no more than about 10 kg/hr, no more than about 9 kg/hr, no more than about 8 kg/hr, no more than about 7 kg/hr, no more than about 6 kg/hr, no more than about 5 kg/hr, no more than about 4 kg/hr, no more than about 3 kg/hr, or no more than about 2 kg/hr of CO₂. Combinations of the above-referenced capture rates are also possible (e.g., at least about 1 kg/hr and no more than about 20 kg/hr or at least about 5 kg/hr and no more than about 15 kg/hr), inclusive of all values and ranges therebetween. In some embodiments, the chemical media can capture about 1 kg/hr, about 2 kg/hr, about 3 kg/hr, about 4 kg/hr, about 5 kg/hr, about 6 kg/hr, about 7 kg/hr, about 8 kg/hr, about 9 kg/hr, about 10 kg/hr, about 11 kg/hr, about 12 kg/hr, about 13 kg/hr, about 14 kg/hr, about 15 kg/hr, about 16 kg/hr, about 17 kg/hr, about 18 kg/hr, about 19 kg/hr, or about 20 kg/hr of CO₂.

In some embodiments, the duration of the adsorption at step 11 can be based on a predetermined desired time. In some embodiments, the duration of the adsorption at step 11 can be based on a concentration of an exhaust stream after contacting the chemical media. For example, if the exhaust stream exiting a vessel, in which the chemical media is contained, increases above a desired level, the adsorption at step 11 can discontinue. In other words, initially the concentration of CO₂ in the exhaust is low, and the contactor performs with high efficiency (i.e., the chemical media adsorbs the maximum amount of CO₂ from the ambient air that it can.) As the cycle continues, the chemical media becomes increasingly saturated with CO₂, and the concentration of CO₂ in the exhaust gas from the reactor increases. In some embodiments, an algorithm can control the starting and stopping of the fan or fans based on inlet and exhaust CO₂ concentrations to minimize total energy required for the adsorption process.

In some embodiments, the fan can blow ambient air onto the chemical media (i.e., the cycle duration of step 11) for a time period of at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, at least about 19 hours, at least about 20 hours, at least about 21 hours, at least about 22 hours, at least about 23 hours, at least about 1 day, at least about 2 days, at least about 3 days, at least about 4 days, at least about 5 days, or at least about 6 days. In some embodiments, the fan or fans can blow air onto the chemical media for a time period of no more than about 7 days, no more than about 6 days, no more than about 5 days, no more than about 4 days, no more than about 3 days, no more than about 2 days, no more than about 1 day, no more than about 1 day, no more than about 23 hours, no more than about 22 hours, no more than about 21 hours, no more than about 20 hours, no more than about 19 hours, no more than about 18 hours, no more than about 17 hours, no more than about 16 hours, no more than about 15 hours, no more than about 14 hours, no more than about 13 hours, no more than about 12 hours, no more than about 11 hours, no more than about 10 hours, no more than about 9 hours, no more than about 8 hours, no more than about 7 hours, no more than about 6 hours, no more than about 5 hours, no more than about 4 hours, no more than about 3 hours, or no more than about 2 hours. Combinations of the above-referenced time periods are also possible (e.g., at least about 1 hour and no more than about 20 hours or at least about 5 hours and no more than about 15 hours), inclusive of all values and ranges therebetween. In some embodiments, the fan can blow ambient air onto the chemical for a time period of about 1 hour, about 2 hours, about 3 hours, about 4 hours, about 5 hours, about 6 hours, about 7 hours, about 8 hours, about 9 hours, about 10) hours, about 11hours, about 12 hours, about 13 hours, about 14 hours, about 15 hours, about 16 hours, about 17 hours, about 18 hours, about 19 hours, about 20 hours, about 21 hours, about 22 hours, about 23 hours, about 1 day, about 2 days, about 3 days, about 4 days, about 5 days, about 6 days, or about 7 days. In some embodiments, the fan or fans can discontinue when the exhaust that has contacted the chemical media can have a CO₂ concentration of at least about 150 ppm, at least about 160 ppm, at least about 170 ppm, at least about 180 ppm, at least about 190 ppm, at least about 200 ppm, at least about 210 ppm, at least about 220 ppm, at least about 230 ppm, at least about 240 ppm, at least about 250 ppm, at least about 260 ppm, at least about 270 ppm, at least about 280 ppm, at least about 290 ppm, at least about 300 ppm, at least about 310 ppm, at least about 320 ppm, at least about 330 ppm, at least about 340 ppm, at least about 350 ppm, at least about 360 ppm, at least about 370 ppm, at least about 380 ppm, at least about 390 ppm, or at least about 400 ppm.

In some embodiments, the adsorption at step 11 can have a duration of at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, or at least about 19 hours. In some embodiments, the adsorption at step 11 can have a duration of no more than about 20 hours, no more than about 19 hours, no more than about 18 hours, no more than about 17 hours, no more than about 16 hours, no more than about 15 hours, no more than about 14 hours, no more than about 13 hours, no more than about 12 hours, no more than about 11 hours, no more than about 10 hours, no more than about 9) hours, no more than about 8 hours, no more than about 7 hours, no more than about 6 hours, no more than about 5 hours, no more than about 4 hours, no more than about 3 hours, or no more than about 2 hours. Combinations of the above-referenced durations of the adsorption at step 11 are also possible (e.g., at least about 1 hour and no more than about 20 hours or at least about 5 hours and no more than about 15 hours), inclusive of all values and ranges therebetween. In some embodiments, the adsorption at step 11 can have a duration of about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, or about 20 hours.

Step 12 includes desorbing at least a portion of CO₂ from chemical media to form a dilute CO₂ stream. In some embodiments, the desorption at step 12 and the adsorption at step 11 can occur in non-overlapping timeframes. In some embodiments, the desorption at step 12 can be at least partially concurrent with the adsorption at step 11.

In some embodiments, the desorbing can occur inside the vessel that contains the chemical media. The desorbing can be via a buffer fluid. In some embodiments, the buffer fluid is recirculated within the vessel that contains the contactor. In some embodiments, the buffer fluid can include a liquid and/or a gas. In some embodiments, the buffer fluid can include air. CO₂. steam (i.e., water vapor at an elevated temperature and/or pressure), or any combination thereof. As desorption occurs, an increasing mass of CO₂ is desorbed from the chemical media. The CO₂ gas mixes and distributes evenly with the buffer fluid and increases the partial pressure of the CO₂ in the buffer fluid. By measuring the partial pressure of CO₂ gas in the buffer fluid, it is possible to determine the amount of CO₂ that has been desorbed and the efficiency of desorption. The buffer fluid can also transfer energy for desorption of the chemical media. In some embodiments, moisture can be added to the buffer fluid to increase the temperature of the buffer fluid to improve desorption of the CO₂ from the chemical media. In some embodiments, the buffer fluid can be heated via a heater to increase the energy transfer from the buffer fluid to the chemical media and the CO₂ for desorption. The use of the buffer fluid as a heat and energy transfer media to allow for desorption to occur can reduce operational expenses associated with the method 10. In some embodiments, other properties of the buffer fluid can be modified to improve the desorption properties of the buffer fluid. In some embodiments, the properties of the buffer fluid can be tailored specifically to the chemical media adsorbing the CO₂.

In some embodiments, step 12 can include thermal desorption, vacuum desorption, pressure swing desorption, humidity swing desorption, temperature swing desorption, or any combination thereof. In some embodiments, the vessel, in which the desorption occurs, can be sealed or fluidically isolated during desorption to minimize the exchange of fluid within the vessel with ambient air located outside of the vessel. In some embodiments, the vessel can be leak tight to a target extent, such that less than a threshold value (e.g., less than about 20 ml, less than about 15 ml, less than about 10 ml, or less than about 5 ml) of fluid from inside the vessel can exit the vessel and/or less than a threshold value (e.g., less than about 20 ml, less than about 15 ml, less than about 10 ml, or less than about 5 ml) of fluid outside the vessel can enter the vessel. In some embodiments, the vessel can be unsealed, such that any significant pressure differential between the inside and the outside of the vessel would result in an exchange of fluid in the direction of a pressure differential. In some embodiments, a gas bag can be used to contain gas and prevent pressure buildup inside the vessel. When the gas bag is included, the partial pressure of CO₂ and other gases within the reactor, and the volume of the buffer fluid can be held constant or near constant. The volume of the reactor vessel and the gas bag can be monitored to quantify the amount of CO₂ desorbed during step 12. In some embodiments, a piston system can be used to contain gas and prevent pressure buildup inside the vessel.

In some embodiments, the desorption at step 12 can occur at ambient pressure. In some embodiments, the desorption at step 12 can occur at an elevated pressure. In some embodiments, the desorption at step 12 can occur below ambient pressure. In some embodiments, the desorption can occur at sub-atmospheric or vacuum pressures by evacuating the reactor vessel prior to starting the desorption. In some embodiments, the pressure of the desorption can be selected based on the chemical media used for adsorption. In some embodiments, a pump, a gas booster, a compressor, and/or a blower can be used to increase the pressure of the buffer fluid and allow the buffer fluid to flow within the vessel to collect CO₂ that is being desorbed and transfer energy to the chemical media to aid in desorption.

In some embodiments, the desorption at step 12 can include contacting the buffer fluid with water (e.g., in a humidifier). The inclusion of water in the buffer fluid can improve the desorption rate of the CO₂ from the chemical media, thereby decreasing the temperature that should be applied to the buffer fluid to achieve a desired desorption. By increasing the water content of the buffer fluid, this energy input requirement can be reduced significantly.

In some embodiments, the desorption at step 12 can have a duration of at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, or at least about 19 hours. In some embodiments, the desorption at step 12 can have a duration of no more than about 20 hours, no more than about 19 hours, no more than about 18 hours, no more than about 17 hours, no more than about 16 hours, no more than about 15 hours, no more than about 14 hours, no more than about 13 hours, no more than about 12 hours, no more than about 11 hours, no more than about 10 hours, no more than about 9 hours, no more than about 8 hours, no more than about 7 hours, no more than about 6 hours, no more than about 5 hours, no more than about 4 hours, no more than about 3 hours, or no more than about 2 hours. Combinations of the above-referenced durations of the desorption at step 12 are also possible (e.g., at least about 1 hour and no more than about 20 hours or at least about 5 hours and no more than about 15 hours), inclusive of all values and ranges therebetween. In some embodiments, the desorption at step 12 can have a duration of about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, or about 20 hours.

Step 13 is optional and includes measuring the CO₂ concentration in the dilute CO₂ stream. In some embodiments, CO₂ concentration can be measured via a pH measurement. In some embodiments, CO₂ concentrations can be measured via a flue gas analyzer, an electrochemical sensor, a non-dispersive infrared (NDIR) sensor, a metal oxide semiconductor (MOS) sensor, or any combination thereof. In some embodiments, CO₂ concentration can be measured via measurement of a volume of a gas bag.

In some embodiments, the dilute CO₂ stream can have a concentration of at least about 0.5 vol %, at least about 1 vol %, at least about 2 vol %, at least about 3 vol %, at least about 4 vol %, at least about 5 vol %, at least about 6 vol %, at least about 7 vol %, at least about 8 vol %, at least about 9 vol %, at least about 10 vol %, at least about 11 vol %, at least about 12 vol %, at least about 13 vol %, at least about 14 vol %, at least about 15 vol %, at least about 16 vol %, at least about 17 vol %, at least about 18 vol %, at least about 19 vol %, at least about 20 vol %, at least about 21 vol %, at least about 22 vol %, at least about 23 vol %, at least about 24 vol %, at least about 25 vol %, at least about 26 vol %, at least about 27 vol %, at least about 28 vol %, at least about 29 vol %, at least about 30 vol %, at least about 31 vol %, at least about 32 vol %, at least about 33 vol %, at least about 34 vol %, at least about 35 vol %, at least about 36 vol %, at least about 37 vol %, at least about 38 vol %, at least about 39 vol %, at least about 40 vol %, at least about 41 vol %, at least about 42 vol %, at least about 43 vol %, at least about 44 vol %, at least about 45 vol %, at least about 46 vol %, at least about 47 vol %, at least about 48 vol %, at least about 49 vol %, at least about 50 vol %, at least about 51 vol %, at least about 52 vol %, at least about 53 vol %, at least about 54 vol %, at least about 55 vol %, at least about 56 vol %, at least about 57 vol %, at least about 58 vol %, at least about 59 vol %. In some embodiments, the dilute CO₂ stream can have a concentration of no more than about 60 vol %, no more than about 59 vol %, no more than about 58 vol %, no more than about 57 vol %, no more than about 56 vol %, no more than about 55 vol %, no more than about 54 vol %, no more than about 53 vol %, no more than about 52 vol %, no more than about 51 vol %, no more than about 50) vol %, no more than about 49 vol %, no more than about 48 vol %, no more than about 47 vol %, no more than about 46 vol %, no more than about 45 vol %, no more than about 44 vol %, no more than about 43 vol %, no more than about 42 vol %, no more than about 41 vol %, no more than about 40 vol %, no more than about 39 vol %, no more than about 38 vol %, no more than about 37 vol %, no more than about 36 vol %, no more than about 35 vol %, no more than about 34 vol %, no more than about 33 vol %, no more than about 32 vol %, no more than about 31 vol %, no more than about 30 vol %, no more than about 29 vol %, no more than about 28 vol %, no more than about 27 vol %, no more than about 26 vol %, no more than about 25 vol %, no more than about 24 vol %, no more than about 23 vol %, no more than about 22 vol %, no more than about 21 vol %, no more than about 20 vol %, no more than about 19 vol %, no more than about 18 vol %, no more than about 17 vol %, no more than about 16 vol %, no more than about 15 vol %, no more than about 14 vol %, no more than about 13 vol %, no more than about 12 vol %, no more than about 11 vol %, no more than about 10 vol %, no more than about 9 vol %, no more than about 8 vol %, no more than about 7 vol %, no more than about 6 vol %, no more than about 5 vol %, no more than about 4 vol %, no more than about 3 vol %, no more than about 2 vol %, or no more than about 1 vol %. Combinations of the above-referenced concentrations are also possible (e.g., at least about 0.5 vol % and no more than about 60 vol % or at least about 10 vol % and no more than about 20 vol %), inclusive of all values and ranges therebetween. In some embodiments, the dilute CO₂ stream can have a concentration of about 0.5 vol %, about 1 vol %, about 2 vol %, about 3 vol %, about 4 vol %, about 5 vol %, about 6 vol %, about 7 vol %, about 8 vol %, about 9) vol %, about 10 vol %, about 11 vol %, about 12 vol %, about 13 vol %, about 14 vol %, about 15 vol %, about 16 vol %, about 17 vol %, about 18 vol %, about 19 vol %, about 20) vol %, about 21 vol %, about 22 vol %, about 23 vol %, about 24 vol %, about 25 vol %, about 26 vol %, about 27 vol %, about 28 vol %, about 29 vol %, about 30 vol %, about 31 vol %, about 32 vol %, about 33 vol %, about 34 vol %, about 35 vol %, about 36 vol %, about 37 vol %, about 38 vol %, about 39 vol %, about 40) vol %, about 41 vol %, about 42 vol %, about 43 vol %, about 44 vol %, about 45 vol %, about 46 vol %, about 47 vol %, about 48 vol %, about 49 vol %, about 50) vol %, about 51 vol %, about 52 vol %, about 53 vol %, about 54 vol %, about 55 vol %, about 56 vol %, about 57 vol %, about 58 vol %, about 59 vol %, or about 60 vol %.

Step 14 is optional and includes adjusting contact time between the buffer fluid and the chemical media based on the measured CO₂ concentration. For example, if the dilute CO₂ stream has a concentration lower than desired, the contact time between the ambient air and the chemical media can be increased. In some embodiments, the intensity of the fan or fans blowing ambient air onto the chemical media can be decreased to increase contact time between the ambient air and the chemical media. In some embodiments, the intensity of the fan or fans blowing ambient air onto the chemical media can be increased to decrease contact time between the ambient air and the chemical media.

Step 15 is optional and includes forming a liquid CO₂ stream, gas CO₂ stream, aqueous CO₂ stream and/or a supercritical CO₂ stream from the dilute CO₂ stream. In some embodiments, the aqueous CO₂ stream can be formed from the buffer fluid. For example, the buffer fluid can include water and the CO₂ can be absorbed into the water. In some embodiments, the buffer fluid can be contacted with a water stream to form the aqueous CO₂ stream. In some embodiments, the aqueous CO₂ can include fresh water. In some embodiments, the aqueous CO₂ can include salt water. In some embodiments, the dilute CO₂ stream can be pressurized to form supercritical CO₂. In some embodiments, the concentrated CO₂ stream can remain in the gas phase when compressed below its critical point.

Step 16 includes storing the dilute stream of CO₂ in a storage volume. In some embodiments, the dilute stream of CO₂ can include supercritical CO₂. In some embodiments, the dilute stream of CO₂ can include an aqueous CO₂ stream. In some embodiments, the dilute stream of CO₂ can be geologically injected into a well. In some embodiments, the dilute stream of CO₂ can be stored in a basalt-rich well.

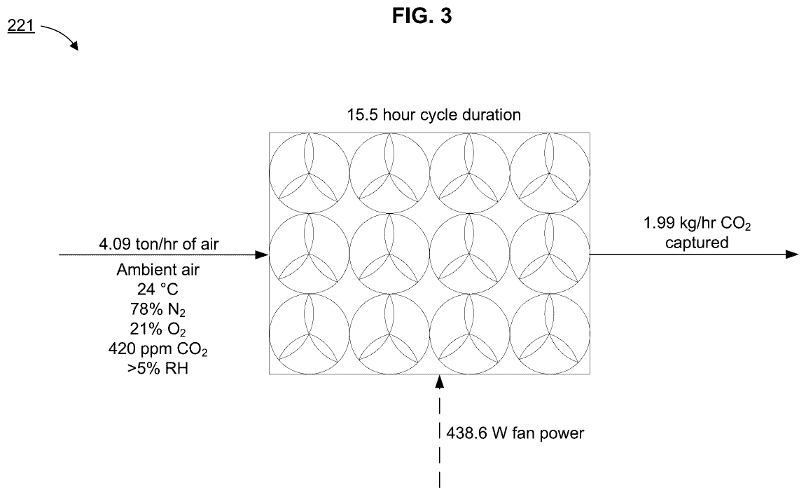

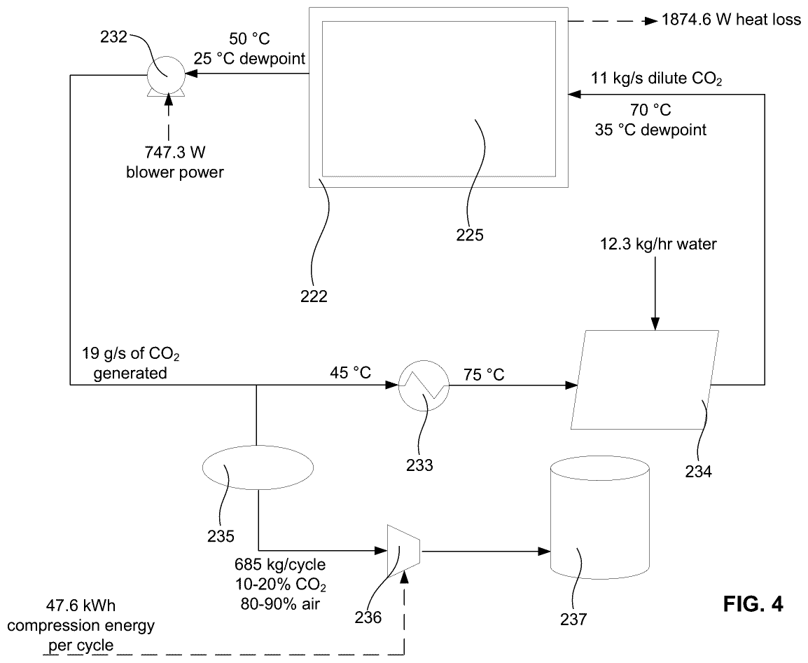

FIG. 3 is an illustration of a set of fans 221 for delivering ambient air to a contactor, according to an embodiment (e.g., for adsorption in step 11, as described above with reference to FIG. 2). FIG. 3 also includes sample calculated values for a mass and energy balance. As shown, the set of fans 221 includes 12 fans arranged in a 3×4 pattern. In some embodiments, the set of fans 221 can include fans arranged in an m×n pattern. In some embodiments, m and/or n can be about 1, about 2, about 3, about 4, about 5, about 6, about 7, about 8, about 9, about 10, about 11, about 12, about 13, about 14, about 15, about 16, about 17, about 18, about 19, about 20, about 30, about 40, about 50, about 60, about 70, about 80, about 90, about 100, about 200, about 300, about 400, about 500, about 600, about 700, about 800, about 900, or about 1,000, inclusive of all values and ranges therebetween. As shown in the material and energy balance, 1.99 kg/hr of CO₂ is captured on the chemical media from an inflow of 4.09 tons/hr of ambient air. The energy input for such an array of fans is calculated to be 438.6 W. As shown, the cycle duration is 15.5 hours. Values shown in FIG. 3 and FIG. 4 are based on exemplary calculations and are not intended to be limiting.

FIG. 4 is an illustration of a contactor vessel 225 that houses a contactor (not shown), and associated equipment during a desorption phase, according to an embodiment. FIG. 4 also includes associated mass and energy values. As shown, an insulating jacket 222 is disposed on the outside of the contactor vessel 225. A blower 232 facilitates movement of a buffer fluid out of the contactor vessel 225. A portion of the buffer fluid is fed to a heater 233 and a humidifier 234 while a portion of the buffer fluid is fed to a gas bag 235 and a compressor 236 prior to entering an intermediary storage volume 237. From the intermediary storage volume 237, the compressed buffer fluid can be transported to a long-term storage volume.

In some embodiments, the contactor can be disposed in the contactor vessel 225 while the contactor vessel 225, the insulating jacket 222, the blower 232, the heater 233, the humidifier 234, the gas bag 235, the compressor 236, and the intermediary storage volume 237 can be housed in an external vessel (not shown), such that the contactor vessel 225, the insulating jacket 222, the blower 232, the heater 233, the humidifier 234, the gas bag 235, the compressor 236, and the intermediary storage volume 237 are not exposed to an ambient environment. In operation, the buffer fluid can pass through the contactor vessel 225 several times before reaching a desired CO₂ saturation level. Hence, at least a portion of the buffer fluid is recirculated back into the contactor vessel 225. As shown, the buffer fluid has a temperature of 50° C, and a dewpoint of 25° C. upon exiting the contactor vessel 225. The blower 232 has an input power of 747.3 W. A total of 19 g/s of CO₂ is retrieved from the contactor. In a 10-hour cycle, 685 kg of CO₂ is retrieved and fed to the gas bag 235 and compressed via the compressor 236 and stored in the intermediary storage volume 237. The volume captured in the gas bag 235 and stored in the intermediary storage volume 237 can be about 10 vol % to about 20 vol % CO₂ and about 80 vol % to about 90 vol % air. The compressor 236 uses 47.6 kWh of compression energy per cycle. In some embodiments, the volume captured in the gas bag 235 can be transferred to the intermediary storage volume 237 near the end of the desorption cycle (e.g., during about the last minute, about the last 2 minutes, about the last 3 minutes, about the last 4 minutes, about the last 5 minutes, about the last 6 minutes, about the last 7 minutes, about the last 8 minutes, about the last 9 minutes, or about the last 10 minutes of the desorption cycle).

As shown, the gas bag 235 is on a separate fluid path from the contactor, the heater 233, and the humidifier 234. In some embodiments, the gas bag 235 can be in-line with the contactor and the blower 232, such that the CO₂ concentration in the gas bag 235 is the same or substantially similar to the CO₂ concentration in the stream that is recirculated through the contactor.

Upon entering the heater 233, the buffer fluid temperature has decreased to 45° C. The heater 233 increases the temperature of the buffer fluid to 75° C. The buffer fluid then passes through the humidifier 234, where 12.3 kg/hr of water is fed to the buffer fluid. The buffer fluid that passes through the humidifier 234 is then transferred back to the contactor vessel 225. The heat provided from the heater 233 and the moisture provided from the humidifier 234 can increase the amount of energy transferred to the contactor to increase the rate of CO₂ desorption. As shown, the contactor vessel 225 loses heat at a rate of 1874.6 W.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list. “or” or “and/or” shall be interpreted as being inclusive, i.e., the inclusion of at least one, but also including more than one, of a number or list of elements, and, optionally. additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either.” “one of,” “only one of.” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A system, comprising:
a contactor including an adsorption medium, the adsorption medium configured to adsorb CO₂ from ambient air;
a circulator configured to circulate a buffer fluid to desorb CO₂ from the adsorption medium to produce dilute CO₂; and
a storage volume configured to store the dilute CO₂.

2. The system of claim 1, wherein the dilute CO₂ has a concentration between about 0.5% and about 60% by volume.

3. The system of claim 1, wherein the dilute CO₂ is stored in the storage volume in the form of at least one of gaseous CO₂, liquid CO₂, supercritical CO₂ or CO₂ dissolved in water.

4. The system of claim 1, wherein the contactor includes a porous honeycomb monolith contactor, the porous honeycomb monolith having a chemical media including the adsorption medium impregnated therein or coated thereon.

5. The system of claim 4, wherein the chemical media includes at least one of an amine, a carbonate, or an alkaline solvent.

6. The system of claim 1, wherein the contactor is contained in a sealed pressure vessel.

7. The system of claim 1, wherein the contactor is contained in a vessel which is not a pressure vessel, such that a significant pressure differential between inside and outside of the vessel would cause movement of fluid in a direction of the pressure differential.

8. The system of claim 1, wherein the storage volume is a first storage volume, the system further comprising:
a second storage volume configured to prevent pressure buildup in a vessel in which the contactor is contained.

9. The system of claim 1, wherein the contactor, the circulator, and the storage volume are each located in the same facility.

10. The system of claim 1, wherein the storage volume is located at a separate facility from the contactor and the circulator.

11. The system of claim 1, further comprising:
a CO₂ sensor configured to measure CO₂ concentration of exhaust leaving a vessel in which the contactor is contained.

12. The system of claim 1, wherein the circulator includes at least one of a blower or a pump.

13. A method comprising:
contacting ambient air with a chemical media to adsorb CO₂ from the ambient air;
desorbing at least a portion of the CO₂ from the chemical media to form a dilute CO₂ stream, the dilute stream of CO₂ having a CO₂ concentration between about 5% and about 60% by volume; and
storing the dilute CO₂ stream in a storage volume.

14. The method of claim 13, wherein the chemical media includes at least one of a solid or a liquid.

15. The method of claim 13, wherein the chemical media includes at least one of an amine, a carbonate, or an alkaline solvent.

16. The method of claim 13, wherein the chemical media is impregnated into or coated onto a contactor, the contactor having a honeycomb monolith shape.

17. The method of claim 13, further comprising:
measuring CO₂ concentration in the dilute CO₂ stream; and
adjusting contact time between a buffer fluid and the chemical media based on the measured CO₂ concentration.

18. The method of claim 13, further comprising:
circulating a buffer fluid to desorb at least a portion of the CO₂ from the chemical media.

19. The method of claim 18, wherein the buffer fluid includes at least one of air, carbon dioxide, or steam.

20. The method of claim 13, wherein the desorption is via at least one of thermal desorption, vacuum desorption, pressure swing desorption, humidity swing desorption, or temperature swing desorption.

21. The method of claim 13, further comprising:
storing at least a portion of the dilute CO₂ stream in a gas bag.

22. The method of claim 13, further comprising:
prior to the storing, mixing the dilute CO₂ stream with water to create a stream where CO₂ is dissolved in water, wherein the CO₂ dissolved in water is stored in the storage volume.

23. The method of claim 21, wherein the water is salt water.

24. The method of claim 21, wherein the water is fresh water.

25. The method of claim 13, further comprising:
prior to the storing, pressurizing the dilute CO₂ stream to form supercritical CO₂, wherein the supercritical CO₂ is stored in the storage volume.

26. The method of claim 13, wherein the adsorption is executed without the application of a vacuum.
